(19) United States
(12) Patent Application Publication
(10) Pub. No.: US 2003/0161257 A1
(43) Pub. Date: Aug. 28, 2003

(54) Optical disk and method of producing the same

(75) Inventors: Keiichiro Yusu, Kanagawa-Ken (JP); Sumio Ashida, Tokyo (JP); Naomasa Nakamura, Kanagawa-Ken (JP); Noritake Oomachi, Chiba-Ken (JP); Katsutaro Ichihara, Kanagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/372,977

(22) Filed: Feb. 26, 2003

(30) Foreign Application Priority Data
Feb. 27, 2002 (JP) 2002-052111

(51) Int. Cl. G11B 3/70; G11B 5/84; G11B 7/26; B32B 3/02; G11B 7/24

(52) U.S. Cl. 369/285; 369/288; 428/64.4; 430/270.13; 428/64.5

(57) ABSTRACT

An optical disk exhibits enhanced overwrite overwrite characteristics and cross-erase suppression. An optical disk includes a flattening layer formed on a substrate; a reflective layer formed on the flattening layer; a phase-change optical recording layer formed on the reflective layer, the recording layer being changeable between crystalline and amorphous states, portions of the recording layer to become the crystalline state exhibiting reflectivity lower than other portions of the recording layer to become the amorphous state; a plurality of dielectric layers stacked on the recording layer, at least two of the dielectric layers having different optical constants; and a light absorbing layer formed at one location selected from a location between the recording layer and the lowermost layer of the dielectric layers, a location between any of two adjacent layers of the dielectric layers, and a location on the uppermost layer of the dielectric layers.

### CROSS REFERENCE TO RELATED APPLICATIONS

This application is based upon and claims the benefit of priority from the prior Japanese Patent Application No. 2002-52111 filed on Feb. 27, 2002, the entire contents of which are incorporated by reference.

### BACKGROUND OF THE INVENTION

The present invention relates to an optical disk on and from which vast amounts of information are optically stored and retrieved, and a method of producing the optical disk.

Advances have been made in studies of optical data recording techniques in the field of data recording. There are many expectations on optical data recording in industry use and also house-hold use for its feasibility of low-cost high-capacity filing. Such expectations come from advantages of optical data recording techniques, such as, non-contact data recording and/or retrieval in the form of read-only type, overwrite-type and rewritable-type memory.

Compact disks (CD), laser disks (LD) and digital versatile discs (DVD) have already in wide use as a read-only type optical disk.

These optical disks have a transparent substrate with uneven patterns such as pits or grooves indicating data signals formed thereon and a metallic thin reflective film of aluminum, etc., formed on the transparent substrate. A protective film is further formed on the reflective film, to protect the reflecting film from oxidation. Data are retrieved based on the difference in reflectivity to incident light beams.

Rewritable phase-change optical disks such as DVD-RAM and DVD-RW have already been on the market. The phase-change optical disks have a first transparent dielectric layer on a transparent substrate; a phase-change recording layer mainly composed of Ge, Sb, Te, In or Ag on the first dielectric layer; a second transparent dielectric layer on the recording layer; a reflective layer of aluminum, etc., on the second dielectric layer; and a protective film of ultraviolet-hardened resin, etc., on the reflective layer.

Data recording and retrieval on and from a rewritable phase-change optical disk require semiconductor laser beams radiated onto a phase-change recording layer on a substrate to cause reversible change between amorphous and crystalline states on data-recorded regions.

Data retrieval is performed based on the change in reflectivity on the data-recorded regions. Data recording requires relatively high-power and short-pulse laser beams radiated onto a phase-change optical material of the recording layer, to rapidly heat data-to-be-recorded regions to a melting point or higher and then rapidly cool the regions, thus forming amorphous recording marks. On the other hand, erasure requires laser beams of lower power and longer pulses than the recording beams, radiated onto the phase-change optical material, to hold the material at a crystallization temperature or higher but lower than the melting point or cool the material from the melting point or higher for crystallization.

Phase-change optical recording/retrieval has the following advantages: a simple optical system in data retrieval from rewritable phase-change optical disks because of sensing the change in reflectivity between the amorphous and crystalline states; no magnetic fields required which are the must for magneto-optical recording; easy overwriting with light modulation and high data-transfer speed; and high compatibility with read-only type disks, such as, DVD-ROM and CD-ROM.

The phase-change optical recording/retrieval offers high-to-low and Lo-to-high media which will be abbreviated to H-L and L-H media, respectively, hereinafter.

The H-L media exhibit high reflectivity on un-recorded regions but low reflectivity on recorded regions whereas the L-H media low on un-recorded regions but high on recorded regions.

Data retrieval from the H-L and L-H media is based on the difference in reflectivity between the recorded and un-recorded regions in phase-change optical retrieval.

In detail, the H-L and L-H media are formed amorphous recording marks on crystallized regions thereof. The reflectivity of the amorphous recording marks on a mirror section thereof is about 1% whereas from 15% to 25% for the crystallized regions, in the H-L media. On the contrary, the reflectivity of the amorphous recording marks on a mirror section thereof is from 20% to 30% whereas from 3% to 10% for the crystallized regions, in the L-H media.

The H-L media are superior to the L-H media for high reflectivity on un-recorded regions, thus easy focusing and tracking being achieved. Nonetheless, the former is inferior to the latter for high average reflectivity even after recording, thus producing large noises.

On the contrary, the L-H media are superior to the H-L modulation for low noises but inferior to the latter on focusing and tracking.

The most different feature between the H-L and L-H media lies in light absorption.

In detail, the light absorption in crystalline regions is lower than in amorphous regions of a recording layer in total-reflection H-L media for which no light absorbing layers are provided other than the recording layer.

Contrary to this, the light absorption in crystalline regions is higher than in amorphous regions of a recording layer in total-reflection L-H media for which no light absorbing layers are provided other than the recording layer.

Discussed below is light absorbing mechanism in overwriting, one of the features of phase-change media.

After initial crystallization, recoding pluses are radiated onto the borders between the crystalline and amorphous regions in forming recording marks.

The radiation of recoding pluses for recording-mark formation will, however, cause difference in temperature rise between the crystalline and amorphous regions due to difference in absorption between the regions.

In detail, the H-L media will exhibit high light absorption on the amorphous regions, thus causing temperature rise in already formed recording marks. The L-H media will, however, exhibit temperature rise in the crystalline regions.

The difference in temperature rise in the crystalline and amorphous regions for the H-L and L-H media could cause recording-mark distortion after overwriting, resulting in retrieval errors.

Another problem that cannot be ignored is cross-erase in which some recording marks formed on adjacent tracks are inevitably erased in succeeding recordings.

In detail, recording beams will also be radiated onto already formed recording marks on adjacent tracks in DVD-RAM disks now on the market. This is because recording is continuously performed on adjacent irregularities with lands and grooves in these DVD-RAM disks.

The H-L media is prone to temperature rise in the recording marks which are then likely to be erased due to high light absorption on the amorphous regions.

Contrary to this, the L-H media are not so prone to temperature rise in the recording marks for low light absorption on the amorphous regions, thus being not so suffering from cross-erase, but still suffering to some extent.

A L-H-medium type optical-disk structure is proposed in Japanese Patent Laid-Open Publication No. 2000-90491. The optical disk has a 3-layer combination of interference and metallic layers on the light-incident side of a recording layer, to attain high light-absorption ratio of crystalline to amorphous regions and a large difference in reflectivity between the crystalline and amorphous regions, for further cross-erase suppression. Nevertheless, this proposal can be applied only to optical disks having a 0.6-mm-thick transparent substrate through which light is allowed to be incident. Moreover, the optical disks under the proposal have a limited structure in which a recording layer and a reflective layer are stacked a transparent substrate in this order.

Short wavelength for light source and high aperture ratio for objective lens could be the key to the next generation high recording-density DVD.

High aperture ratio requires a short focal length for an objective lens, and hence requires a short distance between the objective lens and a recording layer of an optical disk.

Suppose that the proposal in Japanese Patent Laid-Open Publication No. 2000-90491 is adopted for the next generation optical disks. It is required on the supposition that a 0.6-mm-thick transparent substrate through which light is allowed to be incident be replaced with a 0.1-mm-thick polycarbonate sheet, to meet such requirements for high aperture ratio.

It is, hover, practically very difficult to form a recording layer on a 0.1-mm-thick polycarbonate sheet and further a reflective layer on the recording layer.

The adoption of the proposal in Japanese Patent Laid-Open Publication No. 2000-90491 for the next generation optical disks is therefore unrealistic. And, hence the next generation optical disks require further suppression of cross-erase.

As discussed in detail, phase-change optical disks require enhanced overwrite characteristics and cross-erase suppression.

### SUMMARY OF THE INVENTION

The present invention provides an optical disk and a method of producing the optical disk, achieving enhanced overwrite characteristics and cross-erase suppression.

An optical disk according to a first aspect of the present invention includes: a flattening layer formed on a substrate; a reflective layer formed on the flattening layer; a phase-change optical recording layer formed on the reflective layer, the recording layer being changeable between crystalline and amorphous states, portions of the recording layer to become the crystalline state exhibiting reflectivity lower than other portions of the recording layer to become the amorphous state; a plurality of dielectric layers stacked on the recording layer, at least two of the dielectric layers having different optical constants; and a light absorbing layer formed at one location selected from a location between the recording layer and the lowermost layer of the dielectric layers, a location between any of two adjacent layers of the dielectric layers, and a location on the uppermost layer of the dielectric layers.

Moreover, an optical disk according to a second aspect of the present invention includes: an underlying layer formed on a substrate, the underlying layer having a thickness of 5 nm or thicker but thinner than 100 nm, the underlying layer being made of at least one material selected from the group consisting of Al₂O₃, CeO₂, Ce₂O₃, MgF₂, MgCl₂, MgO, Nb₂O₅, Ta₂O₅, Ti₂O₃, Ti₃O₅, TiO₂, V₂O₅, WO₂, W₃O₈, Y₂O₃ and ZrO₂, or a composite of ZnS and SiO₂; a reflective layer formed on the underlying layer; a phase-change optical recording layer formed on the reflective layer, the recording layer being changeable between crystalline and amorphous states, portions of the recording layer to become the crystalline state exhibiting reflectivity lower than other portions of the recording layer to become the amorphous state; a plurality of dielectric layers stacked on the recording layer, at least two of the dielectric layers having different optical constants; and a light absorbing layer formed at one location selected from a location between the recording layer and the lowermost layer of the dielectric layers, a location between any of two adjacent layers of the dielectric layers, and a location on the uppermost layer of the dielectric layers, the light absorbing layer making a ration of the light absorption by the crystalline state to that by the amorphous state in the range from 1.0 to 1.2.

Furthermore, a method of producing an optical disk according to a third aspect of the present invention includes: forming a flattening layer on a substrate; forming a reflective layer on the flattening layer; forming a phase-change optical recording layer on the reflective layer, the recording layer being changeable between crystalline and amorphous states, portions of the recording layer to become the crystalline state exhibiting reflectivity lower than other portions of the recording layer to become the amorphous state; forming a plurality of dielectric layers on the phase-change optical recording layer, at least two dielectric layers having different optical constants; and forming a light absorbing layer at one location selected from a location between the recording layer and the lowermost layer of the dielectric layers, a location between either of two adjacent layers of the dielectric layers, and a location on the uppermost layer of the dielectric layers.

### BRIEF DESCRIPTION OF DRAWINGS

FIG. 1 illustrates a structure of an embodiment of optical disk according to the present invention;

FIG. 2 illustrates a structure of an example 1 to the embodiment of optical disk according to the present invention;

FIG. 3 illustrates overwrite characteristics in the example 1 to the embodiment of optical disk according to the present invention;

FIG. 4 illustrates cross-erase characteristics in the example 1 to the embodiment of optical disk according to the present invention;

FIG. 5 illustrates a structure of an example 2 to the embodiment of optical disk according to the present invention;

FIG. 6 illustrates a structure of an example 3 to the embodiment of optical disk according to the present invention;

FIG. 7 illustrates a structure of an example 4 to the embodiment of optical disk according to the present invention; and

FIG. 8 illustrates a structure of an example 5 to the embodiment of optical disk according to the present invention.

### DETAILED DESCRIPTION OF EMBODIMENTS

An embodiment and several examples according to the present invention will be disclosed with reference to the attached drawings.

A phase-change optical disk according to the present invention has a phase-change optical recording layer that will be switched between crystalline and amorphous states. This transition will occur when the recording layer is irradiated with light beams having a wavelength of 300 nm or longer but 450 nm or shorter incident through a reflective layer formed on a disk substrate.

The phase-change optical disk in this embodiment features reflectivity in the crystalline state lower than that in the amorphous state. It also features a transparent dielectric layer composed of at least two materials, a light absorbing layer composed of one material both formed at light-incident side of the recording layer, and also a flattening layer formed between a substrate and a reflective layer. The flattening layer is provided for decreasing the surface roughness of the reflective layer formed on the flattening layer and also a metallic thin film of the light absorbing layer.

The optical disk exhibits a low-to-high (L-H) mode in which reflectivity in the initial crystalline state will be lower than that in the amorphous state just after formation of films. Data recording and retrieval are performed with light beams through the reflective layer formed on the substrate.

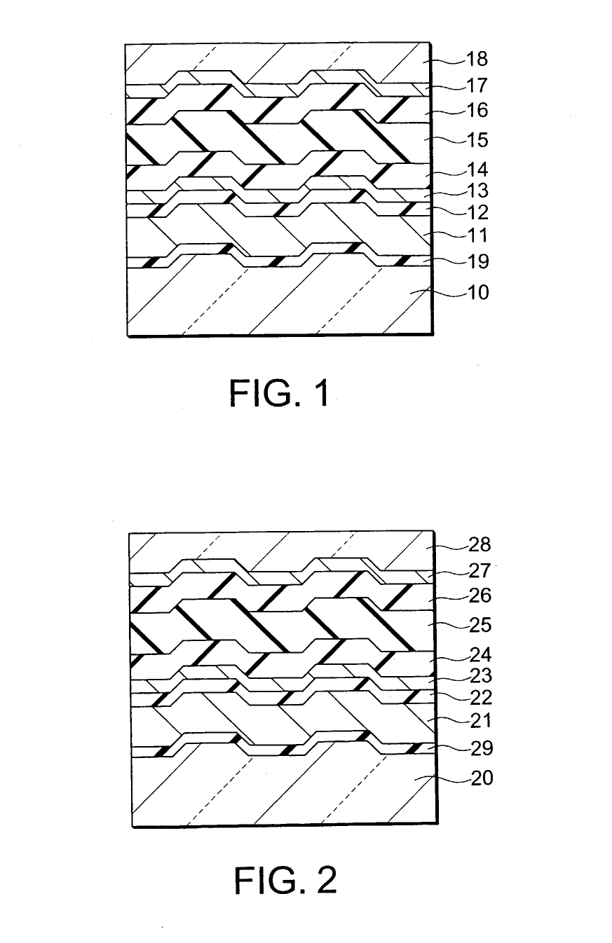

As shown in FIG. 1, the optical disk in this embodiment has a flattening layer 19, a reflective layer 11, a first dielectric layer 12, a recording layer 13, a second dielectric layer 14, a third dielectric layer 15, a fourth dielectric layer 16 and a light absorbing layer 17, stacked in this order on a substrate 10 of a thickness of 1 mm or more. Formed on the light absorbing layer 17 is a transparent sheet 18 of about 0.1 mm in thickness.

Instead of provided on the fourth dielectric layer 16, the light absorbing layer 17 may be provided between the recording layer 13 and the second dielectric layer 14, the second dielectric layer 14 and the third dielectric layer 15 or the third dielectric layer 15 and the fourth dielectric layer 16.

The materials of the second, the third and the fourth dielectric layers 14, 15 and 16 are optical materials different in optical constant. The same material may, however, be used for the second and the fourth dielectric layers 14 and 16.

Moreover, a material that will not exhibit light absorption is a better choice for these dielectric layers 14, 15 and 16, for effective light absorption in the recording layer 13.

A further better choice for such material is a large difference in refraction index over the three dielectric layers. For example, the refraction index for the second and fourth dielectric layers 14 and 16 is 2.0 or higher whereas that for the third dielectric layer 15 is 1.5.

According to such requirements, feasible materials for the second, the third and the fourth dielectric layers 14, 15 and 16 are as follows:

the second layer 14; ZnS or ZnS-composite material, Si₃N₄ or an Si₃N₄-composite material, TiO₂ or a TiO₂-composite material, or AlN or an AlN-composite material;

the third dielectric layer 15; SiO₂ or an SiO₂-composite material, or Al₂O₃ or an Al₂O₃-composite material; and

the fourth layer 16; ZnS or ZnS-composite material, Si₃N₄ or an Si₃N₄-composite material, TiO₂ or a TiO₂-composite material, or AlN or an AlN-composite material.

Combination of the materials listed above offers a large difference in reflectivity between the crystalline and amorphous states for enhanced signal strength in data retrieval.

The light absorbing layer 17 of the optical disk in this embodiment offers the recording layer 13 an almost equal light absorbing capability between the crystalline and amorphous states to achieve high overwrite characteristics and cross-erase suppression.

The light-absorption adjustments in this invention are made under the observations discussed below made by the inventor of the present invention.

Known light-absorption adjustments are made to have Ac/Aa>>1.0 where Ac and Aa indicate light absorption in the crystalline and amorphous states, respectively.

The aim of the known adjustments is to achieve no distortion to a recording mark formed on an un-recorded region as overlapping with an already formed recording mark. The adjustments are made to offer a high light absorption Ac to crystalline regions under consideration of latent heat of melting in the crystalline regions.

The known adjustments could, however, cause poor overwrite characteristics or contribute to cross-erase to erase a portion of an adjacent already formed recording mark.

The reasons for such phenomena areas follows: an actual latent heat of melting is not so high; and rewritable next-generation DVD disks will employ high-speed-erasable recording layer for high transfer speed.

In detail, a high light absorption Ac to crystalline regions will cause temperature rise to the crystalline regions around the already formed recording marks in adjacent tracks. This temperature rise will lead the adjacent marks to start crystallization at the periphery of the marks.

It is thus understood that almost no differences in temperature rise between the crystalline and amorphous regions in the recording layer offer enhanced overwrite characteristics and cross-erase suppression. The inventor of the present invention is the first to reach this conclusion.

Almost no differences in temperature rise between the crystalline and amorphous regions in the recording layer can be achieved by adjustments to these regions to have a ratio of 1:1 for a light absorption Ac in the former region to a light absorption Aa in the latter region.

According to this requirement, the inventor of the present invention carried out several experiments on L-H and H-L media by providing a light absorbing layer so as to have the ratio Ac:Aa=1:1 in the recording layer.

The experiments, however, revealed that a light absorbing layer in H-L media cannot offer the ratio Ac:Aa=1:1 in the recording layer. This is because light absorption in the amorphous regions is higher than that in the crystalline regions in the H-L media.

On the contrary, it was observed that the light absorbing layer 17 (FIG. 1) in the embodiment offers the ratio Ac/Aa in the range from 1.0 to 1.2 to the recording layer 13, with almost no degradation to L-H mode. The ratio Ac/Aa is preferably in the range from 1.0 to 1.1.

Adjustments to have the ratio Ac/Aa in the range from 1.0 to 1.2 for the recording layer 13 are preferably made by providing the light absorbing layer 17 at the light-incident side as shown in FIG. 1, with optical constants, such as, a refraction index “n” in 0.1≦n≦6.0 and an extinction coefficient “k” in 0.3≦k≦5.0.

The thickness of the light absorbing layer 17 for such adjustments requires the thickness of 2 nm or more but 50 nm or less, preferably, 2 nm or more but 20 nm or less.

The best combination of the optical constants and thickness of the light absorbing layer 17 selected among the above ranges by calculation provides optimum optical characteristics to the optical disk in the embodiment. It is known that the optical characteristics of optical disks depends on optical constants and layer thickness.

Not only the arrangements shown in FIG. 1, the light absorbing layer 17 can be provided between the third and the fourth dielectric layers 15 and 16, to achieve the optimum optical characteristics. Preferable requirements to this modification are a refraction index “n” in 2.5.n.4.0, an extinction coefficient “k” in 0.2.k.1.0 and thickness of 2 nm or more but 50 nm or less for the light absorbing layer 17.

Another modification has the light absorbing layer 17 provided between the second and the third dielectric layers 14 and 15, to achieve the optimum optical characteristics. Preferable requirements to this modification are a refraction index “n” in 0.2..n.6.0, an extinction coefficient “k” in 0.2..k.5.0 and thickness of 2 nm or more but 50 nm or less for the light absorbing layer 17.

Still another modification has the light absorbing layer 17 provided between the recording layer 13 and the second dielectric layer 14, to achieve the optimum optical characteristics. Preferable requirements to this modification are a refraction index “n” in 1.0≦n≦6.0, an extinction coefficient “k” in 0.2≦k≦4.5 and thickness of 2 nm or more but 50 nm or less for the light absorbing layer 17.

The best combination of the optical constant and the layer thickness can be calculated to these modifications.

Data recording and retrieval to and from the optical disk in this embodiment require light beams incident to the surface of the light absorbing layer 17.

This type of optical disk is produced by forming a reflective layer, a recording layer and a light absorbing layer stacked in this order on a transparent substrate of about 1.0 mm in thickness.

A metallic thin film of such reflective layer has large concavities and convexities on its surface due to the surface roughness of the underlying substrate surface. The concavities and convexities will be reflected on the surface of a light absorbing layer if it is formed on a recording layer formed on the reflective layer that is directly formed on a substrate. The light absorbing layer also has large concavities and convexities on its surface because it is made of metal.

An average surface roughness Ra for the surface of a polycarbonate substrate is about in the range from 1 to 3 nm whereas that for the reflective layer formed on the substrate is 5 nm or more. Then, the light absorbing layer could have an average surface roughness Ra of 9 nm or more due to the unevenness on the reflective layer. The recording layer is thus affected by the unevenness on the reflective layer so that light beams focused on the recording layer will be scattered on the surface of the light absorbing layer. This results in low cross-erase suppression and overwrite characteristics.

In order to overcome such disadvantages, the embodiment of optical disk according to the present invention is equipped with the flattening layer 19 between the substrate 10 and the reflective layer 11.

The flattening layer 19 serves to decrease surface roughness of the reflective layer 11 and also the light absorbing layer 17 to achieve enhanced overwrite characteristics and cross-erase suppression.

The flattening layer 19 will generate a large free energy ΔG to promote two-dimensional growth of materials formed thereon. It is required for the flattening layer 19 in this embodiment to generate free energy ΔG of −1000 (kJ/mol) or more but −200 (kJ/mol) or less.

The flattening layer 19 is made of Al₂O₃, CeO₂, Ce₂O₃, MgF₂, MgCl₂, MgO, Nb₂O₅, Ta₂O₅, Ti₂O₃, Ti₃O₅, TiO₂, V₂O₅, WO₂, W₃O₈, Y₂O₃ or ZrO₂ or a composite of at least two of these materials or a composite of ZnS and SiO₂.

The thickness of the flattening layer 19 is required to be 5 nm or more but less than 100 nm for decrease in surface roughness. The thickness less than 5 nm will cause difficulty in sequential thin-film production, resulting in less decrease in surface roughness. On the contrary, the thickness of 100 nm or thicker will cause difficulty in formation of lands and grooves on each of the stacked layers on the reflective layer 11 with the same size as those on the substrate 10. Therefore, the most feasible thickness for the flattening layer 19 is 50 nm or less.

These requirements for the flattening layer 19 offer an average roughness Ra of 1 nm or more but 5 nm or less for the surface of metallic films formed on the substrate 10, thus achieving enhanced overwrite characteristics and cross-erase suppression.

Another feature of the optical disk in this embodiment is a gap of 150 nm or less between the substrate 13 and the recording layer 13. This arrangement offers a wide margin to land/groove-width adjustments.

It is a known phenomenon in phase-change optical disks that a recording layer will have a narrower groove width than that on a substrate due to deposition such as sputtering. The difference in groove width will be remarkable as the gap between the substrate and the recording layer becomes wider.

A required groove width for the recording layer can be obtained to some extent by adjusting the groove width for the substrate.

There is, however, a limit to such adjustments, particularly, in the invention, the groove width for the substrate 10 is required to be about 0.3 μm or less for high-density recording. For example, groove/land width of 0.3 μm/0.3 μm for the recording layer 13 requires groove/land width of 0.33 μm/0.27 μm for the substrate 10 in the embodiment. Such adjustments, however, depend on the gap between the substrate 10 and the recording layer 13. The wider the gap, the higher the ratio, for example, 0.4 μm/0.2 μm in groove/land width, which will cause difficulty in disk production.

Under the observation, the embodiment employs a 150-nm-gap between the substrate 10 and the recording layer 13. This requirement will not cause difficulty in disk production while provide flexible land/groove-width adjustments to the recording layer 13.

The feasible requirements for the material used for the recording layer 13 of the optical disk in this embodiment are: reversible transition between crystalline and amorphous states to radiation of light beams of a wavelength in the range from 300 nm to 450 nm; and optical characteristics changeable between crystalline and amorphous states.

Such material for the recording layer 13 may be a three-element composite material, such as, Ge—Sb—Te or In—Sb—Te. The thickness of the recording layer 13 is preferably in the range from 10 nm to 30 nm, for offering high optical contrast to the optical disk.

Each layer (FIG. 1) of the optical disk in this embodiment can be formed by deposition techniques, such as, RF/DC sputtering, electron-beam deposition, resistance-heating deposition and molecular-beam epitaxy (MBE).

Several examples to the embodiment will be disclosed herein below.

### EXAMPLE 1

The example 1, shown in FIG. 2, has a flattening layer 29, a reflective layer 21, a first dielectric layer 22, a recording layer 23, a second dielectric layer 24, a third dielectric layer 25, a fourth dielectric layer 26, a light absorbing layer 27 and a transparent sheet 28, stacked in this order on a substrate 20.

The specifications for the components are as follows:

substrate 20 . . . a 1.1-mm-thick polycarbonate substrate with grooves of 40 nm in depth and 0.3 μm in track pitch;

flattening layer 29 . . . a 30-nm-thick ZnS—SiO₂-made layer;

reflective layer 21 . . . a 100-nm-thick AgPdCu-made layer;

first dielectric layer 22 . . . a 15-nm-thick ZnS—SiO₂-made layer;

recording layer 23 . . . a 15-nm-thick Ge₄₀Sb₈Te₅₂-made layer;

second dielectric layer 24 . . . a ZnS—SiO₂-made layer of any appropriate thickness;

third dielectric layer 25 . . . a 70-nm-thick SiO₂-made layer;

fourth dielectric layer 26 . . . a ZnS—SiO₂-made layer of any appropriate thickness;

light absorbing layer 27 . . . any appropriate thickness; and

transparent sheet 28 . . . a 0.1-mm-thick polycarbonate sheet.

The component layers listed above were formed on the substrate 20 in this order by sputtering, followed by the transparent sheet 28 formed on the light absorbing layer 27 with ultraviolet hardened resin of 2 to 3 μm in thickness.

Five sample phase-change optical disks were produced according to the specifications listed above with the light absorbing layer 27 made of the following five different materials:

Ag . . . n=0.5, k=1.8,

SiCr . . . n=5.3, k=0.3,

WSSi₂ . . . n=3.5, k=3.8,

Al . . . n=0.5, k=5.0, and

SiCr₃ . . . n=1.2, k=0.9

where “n” and “k” indicate a refractive index and an extinction coefficient at 405-nm wavelength.

An optimized thickness for each dielectric layer was obtained as listed in TABLE 1 shown below through optical computation to the five types of light absorbing layer 27 in the phase-change optical disks.

Also produced for comparison is a known-type L-H disk with no such light absorbing layer.

TABLE 1
OPTIMUM LAYER THICKNESS AND
DISK OPTICAL CHARACTERISTICS

| | | | | REFLEC- | | |
|---|---|---|---|---|---|---|
| | THICKNESS (nm) | | | TIVITY (%) | | RATIO |
| LA TYPE | 2nd-DY | 4th-DY | LA | CL | AR | Ac/Aa |
| Ag | 20 | 40 | 10 | 6.5 | 24.6 | 1.05 |
| SiCr | 45 | 75 | 8 | 8.7 | 26.4 | 1.09 |
| WSi₂ | 25 | 30 | 2 | 6.5 | 24.3 | 1.05 |
| Al | 40 | 35 | 6 | 7.6 | 26.0 | 1.02 |
| SiCr₃ | 25 | 30 | 20 | 7.4 | 25.8 | 1.05 |
| No La | 20 | 30 | 0 | 8.0 | 28.9 | 1.30 |

Listed in TABLE 1 are optimum layer thickness and optical characteristics for the five and known optical disks. The term “LA TYPE” means the type of light absorbing layer, in which “No LA” means the known-type L-H disk without light absorbing layer. The terms “DY” and “LA” means the dielectric layer and the light absorbing layer, respectively. The terms “CL” and “AR” means crystalline and amorphous states, respectively.

The term “RATIO” means a ratio of optical absorption in a crystalline region (Ac) to that in an amorphous region (Aa), which indicates an optical-absorption adjusted value.

The reflectivity on the crystalline and the amorphous regions were measured whereas the optical-absorption adjusted values were obtained through computation.

The TABLE 1 teaches that required optical-absorption adjustments were successfully made to the five phase-change optical disks.

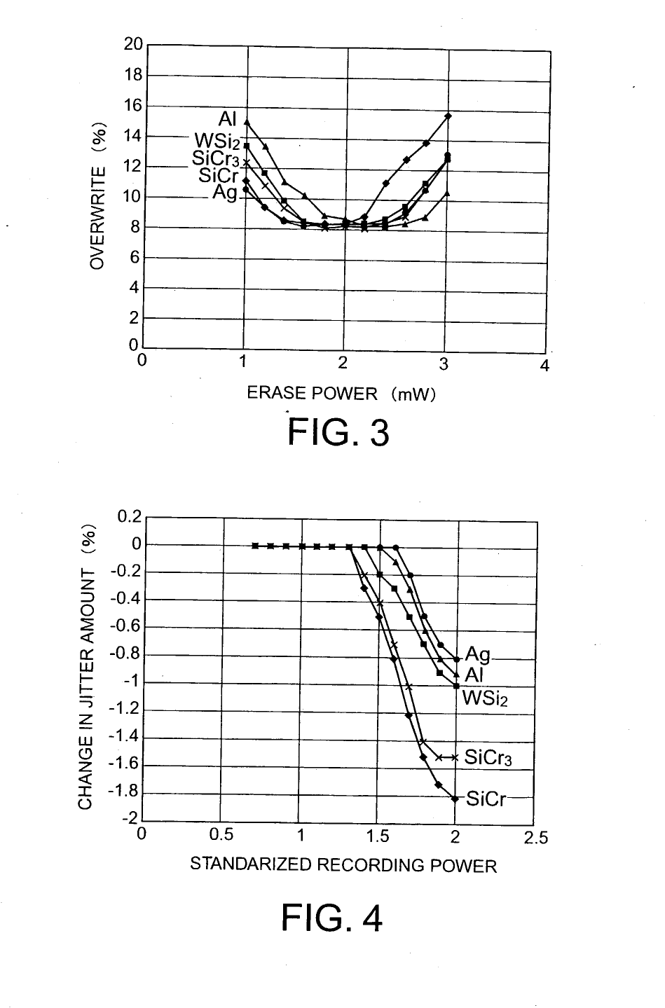

Indicated in FIGS. 3 and 4 are overwrite jitters and cross-erase, respectively, occurred to the five phase-change optical disks according to the following evaluation requirements:

TABLE 2
EVALUATION REQUIREMENTS

| | |
|---|---|
| LASER POWER | 0.1 ˜ 6.0 mW |
| LASER WAVELENGTH | 405 nm |
| DISK ROTATION | 6.0 m/s |
| SPEED (LINEAR | |
| VELOCITY) | |
| OBJECTIVE LENS NA | 0.85 |
| TRACK PITCH | 0.30 μm |
| THE SHORTEST | 0.11 μm |
| PIT LENGTH | |
| RECORDED | RANDOM |
| PATTERN | DATA |
| MODULATION | (8,16)RLL |

Observed in FIG. 3 is that each phase-change optical disk exhibited a favorable jitter characteristics with a wide erase-power margin. Also observed in FIG. 3 is that the five optical disks exhibited different sensitivity to erase laser power in accordance with the light absorption of the five types of light absorbing layer 27.

The cross-erase characteristics, shown in FIG. 4, for each phase-change optical disk was measured as follows:

Random data were recorded in several grooves by an optimum laser power to each phase-change optical disk. Recording laser power is then varied to record data on lands on both sides of each groove. Jitters were measured in the grooves, which were varied over pre-recording and post-recording to the adjacent lands.

Change in the recording laser power was plotted on the abscissa in FIG. 4 as standardized recording power against the optimum recording power to each phase-change optical disk.

FIG. 4 indicates that no cross-erase occurred up to the standardized recording power 1.1 for every phase-change optical disk, particularly, up to 1.5 for the Al-used disk.

As discussed above, the example 1 achieves excellent high overwrite characteristics and cross-erase suppression by using the material Ag, SiCr, SWSi₂, Al or SiCr₃ for the light absorbing layer 27.

The same effects were observed with a crystallization-promoting layer of GeN, SiC or Cr₂O₃ on the recording layer 23.

### EXAMPLE 2

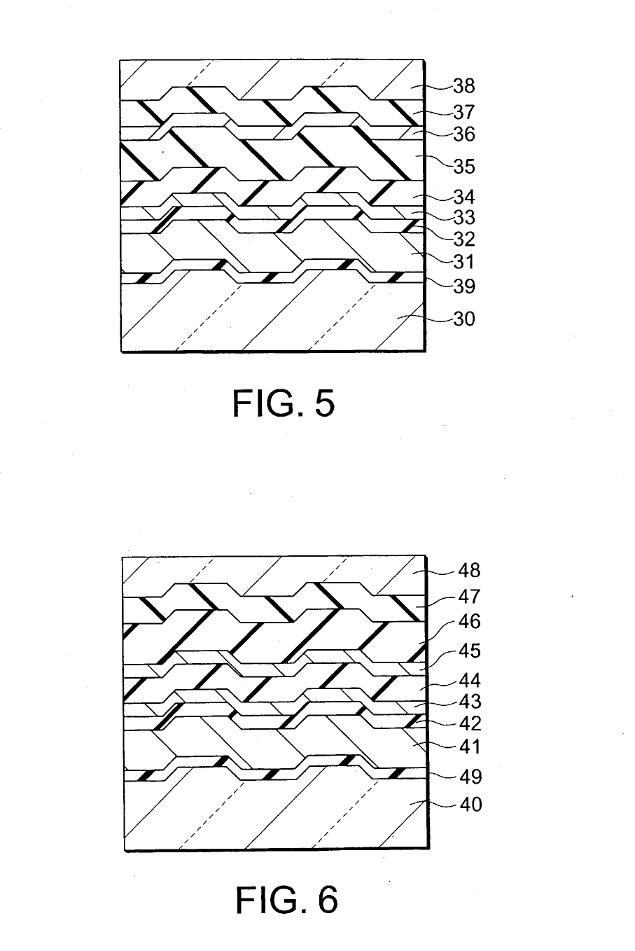

The example 2, shown in FIG. 5, has a flattening layer 39, a reflective layer 31, a first dielectric layer 32, a recording layer 33, a second dielectric layer 34, a third dielectric layer 35, a light absorbing layer 36, a fourth dielectric layer 37 and a transparent sheet 38, stacked in this order on a substrate 30.

The specifications for the components are as follows:

substrate 30 . . . a 1.1-mm-thick polycarbonate substrate with grooves of 40 nm in depth and 0.3 μm in track pitch;

flattening layer 39 . . . a 30-nm-thick ZnS—SiO₂-made layer;

reflective layer 31 . . . a 150-nm-thick AlTi-made layer;

first dielectric layer 32 . . . a 15-nm-thick ZnS—SiO₂-made layer;

recording layer 33 . . . a 15-nm-thick Ge₄₀Sb₈Te₅₂-made layer;

second dielectric layer 34 . . . a 25-nm-thick ZnS—SiO₂-made layer;

third dielectric layer 35 . . . a 100-nm-thick SiO₂-made layer;

light absorbing layer 36 . . . a 4-nm-thick SiCr-made layer;

fourth dielectric layer 37 . . . a 5-nm-thick TiO₂-made layer; and

transparent sheet 38 . . . a 0.1-mm-thick polycarbonate sheet.

The component layers listed above were formed on the substrate 30 in this order by sputtering, followed by the transparent sheet 38 formed on the fourth dielectric layer 37 with ultraviolet hardened resin of 2 to 3 μm in thickness.

The example 2 according to the specifications listed above exhibited 6.9% in reflectivity Rc on crystalline regions, 24.0% in reflectivity Ra on amorphous regions and 1.08 in light-absorption ratio Ac/Aa between the crystalline and amorphous regions.

Evaluation of the example 2 according to the evaluation requirements the same as the example 1 revealed 8.2% in the minimum overwrite jitters while almost no cross-erase jitters occurred to adjacent tracks, up to the standardized recording power 1.4.

As discussed above, the example 2 also achieves excellent high overwrite characteristics and cross-erase suppression, with the SiCr-made light absorbing layer 36 provided between the third and the fourth dielectric layers 35 and 37.

The same effects were observed with a crystallization-promoting layer of GeN, SiC or Cr₂O₃ on the recording layer 33.

### EXAMPLE 3

The example 3 to the embodiment, shown in FIG. 6, has a flattening layer 49, a reflective layer 41, a first dielectric layer 42, a recording layer 43, a second dielectric layer 44, a light absorbing layer 45, a third dielectric layer 46, a fourth dielectric layer 47 and a transparent sheet 48, stacked in this order on a substrate 40.

The specifications for the components are as follows:

substrate 40 . . . a 1.1-mm-thick polycarbonate substrate with grooves of 40 nm in depth and 0.3 μm in track pitch;

flattening layer 49 . . . a 30-nm-thick ZnS—SiO₂-made layer;

reflective layer 41 . . . a 100-nm-thick AgPdCu-made layer;

first dielectric layer 42 . . . a 15-nm-thick ZnS—SiO₂-made layer;

recording layer 43 . . . a 15-nm-thick Ge₃₅Sb₁₂Te₅₃-made layer;

second dielectric layer 44 . . . a 15-nm-thick ZnS—SiO₂-made layer;

light absorbing layer 45 . . . a 2-nm-thick Ge-made layer;

third dielectric layer 46 . . . an 85-nm-thick Al₂O₃-made layer;

fourth dielectric layer 47 . . . a 20-nm-thick Si₃N₄-made layer; and

transparent sheet 48 . . . a 0.1-mm-thick polycarbonate sheet.

The component layers listed above were formed on the substrate 40 in this order by sputtering, followed by the transparent sheet 48 formed on the fourth dielectric layer 47 with ultraviolet hardened resin of 2 to 3 μm in thickness.

The example 3 according to the specifications listed above exhibited 5.4% in reflectivity Rc on crystalline regions, 24.4% in reflectivity Ra on amorphous regions and 1.00 in light-absorption ratio Ac/Aa between the crystalline and amorphous regions.

Evaluation of the example 3 according to the evaluation requirements the same as the example 1 revealed 7.9% in the minimum overwrite jitters while almost no cross-erase jitters occurred to adjacent tracks, up to the standardized recording power 1.5.

As discussed above, the example 3 also achieves excellent high overwrite characteristics and cross-erase suppression, with the Ge-made light absorbing layer 45 provided between the second and the third dielectric layers 44 and 46.

The same effects were observed with a crystallization-promoting layer of GeN, SiC or Cr₂O₃ on the recording layer 43.

### EXAMPLE 4

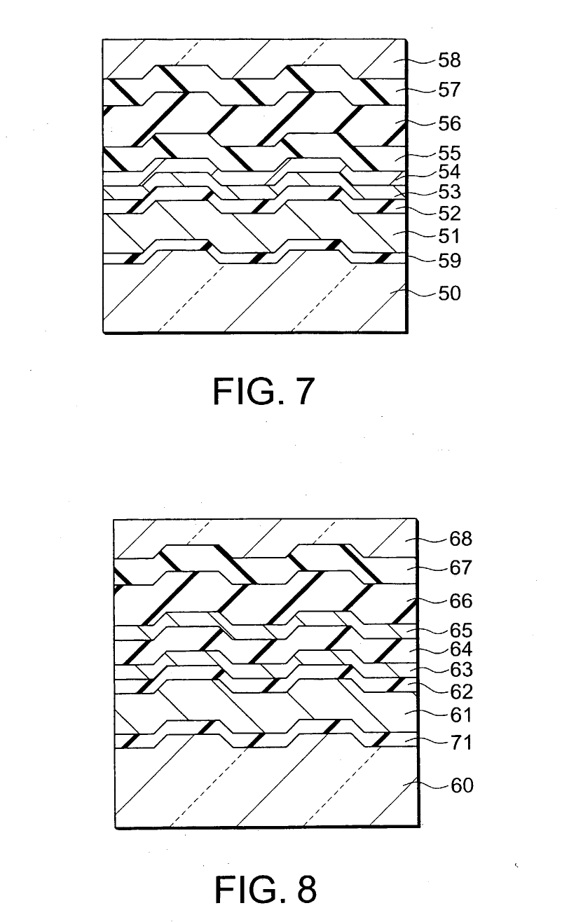

The example 4 to the embodiment, shown in FIG. 7, has a flattening layer 59, a reflective layer 51, a first dielectric layer 52, a recording layer 53, a light absorbing layer 54, a second dielectric layer 55, a third dielectric layer 56, a fourth dielectric layer 57 and a transparent sheet 58, stacked in this order on a substrate 50.

The specifications for the components are as follows:

substrate 50 . . . a 1.1-mm-thick polycarbonate substrate with grooves of 40 nm in depth and 0.3 μm in track pitch;

flattening layer 59 . . . a 30-nm-thick ZnS—SiO₂-made layer;

reflective layer 51 . . . a 150-nm-thick AlMo-made layer;

first dielectric layer 52 . . . a 15-nm-thick ZnS—SiO₂-made layer;

recording layer 53 . . . a 15-nm-thick Ge₃₅Sb₁₂Te₅₃-made layer;

light absorbing layer 54 . . . a 4-nm-thick Ti-made layer;

second dielectric layer 55 . . . a 20-nm-thick Si₃N₄-made layer;

third dielectric layer 56 . . . a 60-nm-thick SiO₂-made layer;

fourth dielectric layer 57 . . . a 50-nm-thick AlN-made layer; and

transparent sheet 58 . . . a 0.1-mm-thick polycarbonate sheet.

The component layers listed above were formed on the substrate 50 in this order by sputtering, followed by the transparent sheet 58 formed on the fourth dielectric layer 57 with ultraviolet hardened resin of 2 to 3 μm in thickness.

The example 4 according to the specifications listed above exhibited 8.2% in reflectivity Rc on crystalline regions, 25.5% in reflectivity Ra on amorphous regions and 1.07 in light-absorption ratio Ac/Aa between the crystalline and amorphous regions.

Evaluation of the example 4 according to the evaluation requirements the same as the example 1 revealed 8.0% in the minimum overwrite jitters while almost no cross-erase jitters occurred to adjacent tracks, up to the standardized recording power 1.4.

As discussed above, the example 4 also achieves excellent high overwrite characteristics and cross-erase suppression, with the Ti-made light absorbing layer 54 provided between the recording layer 53 and the second dielectric layer 55.

The same effects were observed with a crystallization-promoting layer of GeN, SiC or Cr₂O₃ on the recording layer 54.

### EXAMPLE 5

The example 5, shown in FIG. 8, has a flattening layer 71, a reflective layer 61, a first dielectric layer 62, a recording layer 63, a second dielectric layer 64, a light absorbing layer 65, a third dielectric layer 66, a fourth dielectric layer 67 and a transparent sheet 68, stacked in this order on a substrate 60.

The specifications for the components are as follows:

substrate 60 . . . a 1.1-mm-thick polycarbonate substrate with grooves of 40 nm in depth and 0.3 μm in track pitch, and 1.0 in land/groove ratio L/G;

flattening layer 71 . . . a 10-nm-thick ZnS—SiO₂-made layer;

reflective layer 61 . . . an AlMo-made layer of any appropriate thickness;

first dielectric layer 62 . . . a 25-nm-thick ZnS—SiO₂-made layer;

recording layer 63 . . . a 15-nm-thick Ge₃₅Sb₁₂Te₅₃-made layer;

second dielectric layer 64 . . . a 20-nm-thick ZnS—Si₃N₄-made layer;

light absorbing layer 65 . . . an 8-nm-thick AgPdCu-made layer;

third dielectric layer 66 . . . a 90-nm-thick SiO₂-made layer;

fourth dielectric layer 67 . . . a 45-nm-thick ZnS—SiO₂-made layer; and

transparent sheet 68 . . . a 0.1-mm-thick polycarbonate sheet.

The component layers listed above were formed on the substrate 60 in this order by sputtering, followed by the transparent sheet 68 formed on the fourth dielectric layer 67 with UV-hardened resin of 2 to 3 μm in thickness.

Six sample phase-change optical disks were produced according to the specifications listed above with the AlMo-made reflective layer 61 having six different thicknesses in the range from 90 nm to 190 nm with a 20-nm interval for different substrate-recording layer gaps.

Every sample disk in the example 5 according to the specifications listed above exhibited about 4% in reflectivity Rc on crystalline regions, about 23.0% in reflectivity Ra on amorphous regions and 1.05 in light-absorption ratio Ac/Aa between the crystalline and amorphous regions. Almost no optical variations were observed over the six sample disks.

It was also found that the thickness of 90 nm or more for the AlMo-made reflective layer 61 require little change in disk-cooling mechanism.

Listed in TABLE 3 are ratios of land to groove on the recording layer in accordance with the gap between the substrate and the recording layer, observed over the six sample phase-change optical disks.

TABLE 3
SUBSTRATE-RECORDING LAYER GAP,
RECORDING LAYER L/G

| RY THICKNESS (nm) | SU-RY GAP (nm) | RY L/G RATIO |
|---|---|---|
| 90 | 125 | 1.29 |
| 110 | 145 | 1.34 |
| 130 | 165 | 1.39 |
| 150 | 185 | 1.44 |
| 170 | 205 | 1.50 |
| 190 | 225 | 1.55 |

The term “RY THICKNESS” in TABLE 3 means the six different thicknesses of the AlMo-made reflective layer 61 over the six sample phase-change optical disks. The term “SU-RY GAP” means the gaps between the substrate 60 and the recording layer 63 in accordance with the thicknesses of the reflective layer 61. The term “RY L/G RATIO” means the ratio of land (L) to groove (G) on the recording layer 63.

TABLE 3 teaches that the land/groove ratio L/G of 1.0 for the substrate 60 was increased to 1.29, 1.34, . . . , for the recording layer 63, as the gap between the substrate 60 and the recording layer 63 became wider. This means that the bottom of each groove on the recording layer 63 narrowed due to deposition of films on the slope of the groove, to cause increase in land/groove ratio L/G.

Feasible land/groove characteristics require the land/groove ratio of 1.0 for the recording layer 63 that is achieved by pre adjustments to the land/groove ratio for the substrate 60.

It is also found from TABLE 3 that the L/G ratio of 1.0 for the recording layer 63 can be achieved with a L/G ratio of 0.78 for the substrate 60, which is the inversion of 1.29.

For example, the L/G ratio of 1.0 for the recording layer 63 requires 0.26 μm in land width and 0.34 μm in groove width for the substrate 60 to a 125-nm gap between the substrate 60 and the recording layer 63. It requires 0.25 μm in land width and 0.35 μm in groove width for the substrate 60 when the gap is 165 nm between the substrate 60 and the recording layer 63.

It is, however, very difficult to achieve the land width of 0.25 μm or less under the current processing technology in view of processing accuracy, reproducibility, yields, and so on.

The observation concludes that a recommendable range of gap between the substrate 60 and the recording layer 63 is at most 165 nm or less, preferably, 150 nm or less.

The phase-change optical disks in the example 5 are therefore designed to have at most 165 nm or less for the gap between the substrate 60 and the recording layer 63 m, which offers a wide design margin to substrate production.

### EXAMPLE 6

Disclosed next with reference to FIG. 8 and TABLE 4 is the example 6 to the optical disk according to the present invention.

Ten sample optical disks were produced with a 80-nm-thick AlMo-reflective layer 61 and a 30-nm-thick flattening layer 71 made of ten materials, for examination of the dependency on flattening-layer materials.

The ten materials are Cu, Al₂O₃, CeO₂ (80 at %)-MgO(20 at %), CeO₂ (90 at %)-MgF₂ (10 at %), Nb₂O₅, Ta₂O₅, TiO₂, V₂O₅ (50 at %)-WO₂ (50 at %), Y₂O₃ (90 at %)-ZrO₂ (10 at %) and ZnS (75 at %)-SiO₂ (25 at %).

The nine samples are optical disks under the example 6 except the one having the Cu-flattening layer 71. This is because Cu will generate free energy of 46 KJ/mol that is out of the feasible range of free energy from −1000 to −200 KJ/mol to the flattening layer 71 in the example 6.

Accelerated tests were performed to the ten sample optical disks with the ten types of the flatting layers 71 and also other eleven sample disks with no flatting layers, for 20 hours at 80° C. and 90% in moisture, after test recording in accordance with the evaluation requirements in TABLE 2.

The eleven sample disks were produced each with a light absorbing layer as the top layer on multiple layers stacked on a carbonate substrate, like optical disks, for observation of average surface roughness Ra under an atomic force microscope.

Listed in TABLE 4 are lifetime (archive characteristics) of data recorded on the disks at test recording and recording (shelf) characteristics after accelerated degradation, and also average surface roughness Ra to the 10 sample optical disks and the other 11 sample disks.

TABLE 4

| | | | AVERAGE |
|---|---|---|---|
| | | | ROUGHNESS |
| | JITTER (%) | | Ra |
| FLATTENING LAYER | ARCHIVE | SHELF | (nm) |
| none | 12.6 | 11.8 | 9.5 |
| Cu | 13.9 | 12.6 | 11.3 |
| Al₂O₃ | 8.3 | 7.9 | 2.9 |
| CeO₂ (at 80%) − MgO (at 20%) | 8.5 | 8.2 | 3.3 |
| CeO₂ (90 at %) − MgF₂ (at 10%) | 8.3 | 7.9 | 3.0 |
| Nb₂O₅ | 7.9 | 7.7 | 2.6 |
| Ta₂O₅ | 7.5 | 7.1 | 2.2 |
| TiO₂ | 7.8 | 7.8 | 2.8 |
| V₂O₅ (50 at %) − Wo₂ (50 at %) | 8.2 | 8.0 | 2.9 |
| Y₂O₃ (90 at %) − ZrO₂ (10 at %) | 8.7 | 8.4 | 3.4 |
| ZnS (75 at %) − SiO₂ (25 at %) | 7.4 | 7.3 | 2.3 |

The followings are taught by TABLE 4:

The 10 sample optical disks having the ten types of the flatting layers 71 (example 6) exhibited favorable jitters of 9% or lower on both the archive and shelf characteristics. In contrast, the eleven sample disks with no flatting layers exhibited jitters over 12% on the archive characteristics. Moreover, the optical disk having the Cu-flattening layer 71 exhibited jitters over 13% on the archive characteristics.

When it comes to the average surface roughness Ra, the sample disks with no flatting layers exhibited 9 nm or more, which goes beyond 11 nm for the optical disk having the Cu-flattening layer 71, matching the unfavorable jitter characteristics.

On the contrary, the optical disks having the flatting layers 71 (example 6) exhibited the average surface roughness Ra of less than 4 nm, well improved and matching the favorable jitter characteristics.

It is thus revealed that jitter-decreasing effects can be achieved with the flatting layer 71 made of one of the materials Al₂O₃, CeO₂ (80 at %)-MgO (20 at %), CeO₂ (90 at %)-MgF₂ (10 at %), Nb₂O₅, Ta₂O₅, TiO₂, V₂O₅ (50 at %)-WO₂ (50 at %), Y₂O₃ (90 at %)-ZrO₂ (10 at %) and ZnS (75 at %)-SiO₂ (25 at %).

The jitter-decreasing effects can also be achieved with the flatting layer 71 made of one of the materials Ce₂O₃, MgCl₂, Ti₂O₃, Ti₃O₅, and W₃O₈, a composite of at least two of these materials, or a composite of at least one of these materials with any compound listed in TABLE 4.

As disclosed in detail, the present invention achieves high overwrite characteristics and cross-erase suppression in phase-change optical disks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. An optical disk comprising:
a flattening layer formed on a substrate;
a reflective layer formed on the flattening layer;
a phase-change optical recording layer formed on the reflective layer, the recording layer being changeable between crystalline and amorphous states, portions of the recording layer to become the crystalline state exhibiting reflectivity lower than other portions of the recording layer to become the amorphous state;
a plurality of dielectric layers stacked on the recording layer, at least two dielectric layers having different optical constants; and
a light absorbing layer formed at one location selected from a location between the recording layer and the lowermost layer of the dielectric layers, a location between any of two adjacent layers of the dielectric layers, and a location on the uppermost layer of the dielectric layers.

2. The optical disk according to claim 1, wherein the light absorbing layer makes a ratio of the light absorption by the crystalline state to that by the amorphous state exhibit in the range from 1.0 to 1.2.

3. The optical disk according to claim 1, wherein a gap between the substrate and the phase-change optical recording layer is 150 nm or narrower.

4. The optical disk according to claim 1, wherein the phase-change optical recording layer is changeable between the crystalline and amorphous states to irradiation of light having a wavelength of 300 nm or longer but 400 nm or shorter.

5. The optical disk according to claim 1 further comprising a first dielectric layer formed on the reflective layer, the phase-change optical recording layer being formed on the first dielectric layer, the dielectric layers in which at least two layers have different optical constants being second to fourth dielectric layers.

6. The optical disk according to claim 5, wherein the light absorbing layer is formed on the fourth dielectric layer.

7. The optical disk according to claim 6, wherein the light absorbing layer have a thickness of 2 nm or thicker but 50 nm or thinner, exhibiting a refraction index of 0.1 or higher but 6.0 or lower and an extinction coefficient of 0.3 or higher but 5.0 or lower.

8. The optical disk according to claim 5, wherein the light absorbing layer is formed between the third and the fourth dielectric layers.

9. The optical disk according to claim 8, wherein the light absorbing layer have a thickness of 2 nm or thicker but 50 nm or thinner, exhibiting a refraction index of 2.5 or higher but 4.0 or lower and an extinction coefficient of 0.2 or higher but 1.0 or lower.

10. The optical disk according to claim 5, wherein the light absorbing layer is formed between the second and the third dielectric layers.

11. The optical disk according to claim 10, wherein the light absorbing layer have a thickness of 2 nm or thicker but 50 nm or thinner, exhibiting a refraction index of 0.2 or higher but 6.0 or lower and an extinction coefficient of 0.2 or higher but 5.0 or lower.

12. The optical disk according to claim 5, wherein the light absorbing layer is formed between phase-change optical recording layer and the second dielectric layer.

13. The optical disk according to claim 12, wherein the light absorbing layer have a thickness of 2 nm or thicker but 50 nm or thinner, exhibiting a refraction index of 1.0 or higher but 6.0 or lower and an extinction coefficient of 0.2 or higher but 4.5 or lower.

14. The optical disk according to claim 1, wherein the flattening layer has a thickness of 5 nm or thicker but thinner than 100 nm, the flattening layer being made of at least one material selected from the group consisting of Al₂O₃, CeO₂, Ce₂O₃, MgF₂, MgCl₂, MgO, Nb₂O₅, Ta₂O₅, Ti₂O₃, Ti₃O₅, TiO₂, V₂O₅, WO₂, W₃O₈, Y₂O₃ and ZrO₂, or a compound of ZnS and SiO₂.

15. The optical disk according to claim 5, wherein the second dielectric layer is made of ZnS, Si₃N₄, TiO₂, AlN, a ZnS-composite material, an Si₃N₄-composite material, a TiO₂-composite material, or an AlN-composite material, the third dielectric layer is made of SiO₂, Al₂O₃, an SiO₂-composite material, or an Al₂O₃-composite material, and the fourth dielectric layer is made of ZnS, Si₃N₄, TiO₂, AlN, a ZnS-composite material, an Si₃N₄-composite material, a TiO₂-composite material, or an AlN-composite material.

16. An optical disk comprising:
an underlying layer formed on a substrate, the underlying layer having a thickness of 5 nm or thicker but thinner than 100 nm, the underlying layer being made of at least one material selected from the group consisting of Al₂O₃, CeO₂, Ce₂O₃, MgF₂, MgCl₂, MgO, Nb₂O₅, Ta₂O₅, Ti₂O₃, Ti₃O₅, TiO₂, V₂O₅, WO₂, W₃O₈, Y₂O₃ and ZrO₂, or a composite of ZnS and SiO₂;
a reflective layer formed on the underlying layer;
a phase-change optical recording layer formed on the reflective layer, the recording layer being changeable between crystalline and amorphous states, portions of the recording layer to become the crystalline state exhibiting reflectivity lower than other portions of the recording layer to become the amorphous state;
a plurality of dielectric layers stacked on the recording layer, at least two of the dielectric layers having different optical constants; and
a light absorbing layer formed at one location selected from a location between the recording layer and the lowermost layer of the dielectric layers, a location between any of two adjacent layers of the dielectric layers, and a location on the uppermost layer of the dielectric layers, the light absorbing layer making a ratio of the light absorption by the crystalline state to that by the amorphous state exhibit in the range from 1.0 to 1.2.

17. The optical disk according to claim 16 further comprising a first dielectric layer formed on the reflective layer, the phase-change optical recording layer being formed on the first dielectric layer, the dielectric layers in which at least two layers have different optical constants being second to fourth dielectric layers.

18. The optical disk according to claim 17, wherein the light absorbing layer is formed on the fourth dielectric layer, the light absorbing layer having a thickness of 2 nm or thicker but 50 nm or thinner and exhibiting a refraction index of 0.1 or higher but 6.0 or lower and an extinction coefficient of 0.3 or higher but 5.0 or lower.

19. The optical disk according to claim 17, wherein the light absorbing layer is formed between the third and the fourth dielectric layers, the light absorbing layer having a thickness of 2 nm or thicker but 50 nm or thinner and exhibiting a refraction index of 2.5 or higher but 4.0 or lower and an extinction coefficient of 0.2 or higher but 1.0 or lower.

20. The optical disk according to claim 17, wherein the light absorbing layer is formed between the second and the third dielectric layers, the light absorbing layer having a thickness of 2 nm or thicker but 50 nm or thinner and exhibiting a refraction index of 0.2 or higher but 6.0 or lower and an extinction coefficient of 0.2 or higher but 5.0 or lower.

21. The optical disk according to claim 17, wherein the light absorbing layer is formed between the phase-change optical recording layer and the second dielectric layer, the light absorbing layer having a thickness of 2 nm or thicker but 50 nm or thinner, exhibiting a refraction index of 1.0 or higher but 6.0 or lower and an extinction coefficient of 0.2 or higher but 4.5 or lower.

22. A method of producing an optical disk comprising:
forming a flattening layer on a substrate;
forming a reflective layer on the flattening layer;
forming a phase-change optical recording layer on the reflective layer, the recording layer being changeable between crystalline and amorphous states, portions of the recording layer to become the crystalline state exhibiting reflectivity lower than other portions of the recording layer to become the amorphous state;
forming a plurality of dielectric layers on the phase-change optical recording layer, at least two of the dielectric layers having different optical constants; and
forming a light absorbing layer at one location selected from a location between the recording layer and the lowermost layer of the dielectric layers, a location between any of two adjacent layers of the dielectric layers, and a location on the uppermost layer of the dielectric layers.
